(19) United States
(12) Patent Application Publication
(10) Pub. No.: US 2018/0376202 A1
(43) Pub. Date: Dec. 27, 2018

(54) APPARATUS AND METHOD OF PROVIDING CONTENTS

(71) Applicant: Carbosys Co., Ltd., Paju-si (KR)

(72) Inventor: Seung CHO, Paju-si (KR)

(73) Assignee: Carbosys Co., Ltd., Paju-si (KR)

(21) Appl. No.: 15/697,866

(22) Filed: Sep. 7, 2017

(30) Foreign Application Priority Data
Jun. 26, 2017 (KR) 10-2017-0080530

(51) Int. Cl. H04N 21/45; H04N 21/485; H04N 21/462

(52) U.S. Cl. CPC H04N 21/4532; H04N 21/462; H04N 21/485

(57) ABSTRACT

The present invention relates to an apparatus and a method of providing contents, and more particularly, to an apparatus and a method of providing contents, which generate a channel map based on information about preferred contents received from a user and provide the user with various contents by using the generated channel map, thereby providing various kinds of dispersed contents according to preference of the user.

### CROSS-REFERENCE TO RELATED APPLICATIONS

This application claims priority to and the benefit of Korean Patent Application No. 10-2017-0080530 filed in the Korean Intellectual Property Office on Jun. 26, 2017, the entire contents of which are incorporated herein by reference.

### TECHNICAL FIELD

The present invention relates to an apparatus and a method of providing contents, and more particularly, to an apparatus and a method of providing contents, which generate a channel map based on information about preferred contents received from a user and provide the user with various contents by using the generated channel map, thereby selectively providing only the contents preferred by the user among the various kinds of dispersed contents.

### BACKGROUND ART

In general, a content providing apparatus is mainly a device provided by a communication company, and is formed of a set top box and contents provided by the communication company. Herein, the set top box is a device, which is connected with a content outputting device, such as a TV, a desk top computer, and a notebook computer, capable of outputting contents, receives a signal input from the outside and converts the signal to a signal playable in the content outputting device, and transmits the converted signal to the content outputting device to enable the contents to be output.

The content outputting device connected with the set top box has advantages in receiving cable broadcasting, satellite broadcasting, and the like through various channels, as well as existing public broadcasting, and receiving several tens to several hundreds of contents. However, the user does not need all of the various channels, so that there is a problem in that the user has a difficulty in selecting and receiving his/her preferred contents among the several hundreds of contents.

In order to solve the problem, a preference-based content providing apparatus, in which a user sets preferred specific channels in advance, searches for only the set preferred channels, and receives necessary contents through a desired channel among the preferred channels, is used.

In the meantime, the preference-based content providing apparatus in the related art may receive only partial contents, such as contents provided by a communication company and contents provided by a broadcasting company, and has a problem in failing to receive the various kinds of dispersed contents, such as one-person media including YouTube and Podcast. Further, even though the preference-based content providing apparatus plays one-person media, such as YouTube and Podcast, the preference-based content providing apparatus inconveniently needs to stop existing broadcasting which is currently being played, and be driven through a separate connection.

In this respect, in order to solve the problem of the preference-based content providing apparatus in the related art, the present inventor develops an apparatus and a method of providing contents, which generate a channel map based on information about preferred contents received from a user and provide the user with various contents by using the generated channel map, thereby selectively providing only the contents preferred by the user among the various kinds of dispersed contents.

### RELATED ART LITERATURE

### Patent Document

Korean Patent Application Laid-Open No. 10-2008-0011489

### SUMMARY OF THE INVENTION

The present invention has been made in an effort to provide an apparatus and a method of providing contents, which register one or more contents based on information about the one or more contents received from a user terminal and generate a channel map and provide the user terminal or a content outputting device with the contents registered in the generated channel map, thereby selectively providing the various kinds of dispersed contents according to preference of the user.

An exemplary embodiment of the present invention provides an apparatus for providing contents, the apparatus including: a communication unit which receives one or more elements of content information from a user terminal; a channel map generating unit which registers one or more contents and generates a channel map based on the one or more elements of received content information; and a channel map storing unit which stores the generated channel map, in which the communication unit provides an external server with the generated channel map or receives a previously generated channel map from the external server, and the channel map storing unit stores any one or more of the generated channel map and the previously generated channel map.

The apparatus may further include a content providing unit which provides a content outputting device with one or more contents registered in the channel map stored in the channel map storing unit, in which when the content providing unit receives a content request signal from the user terminal, the content providing unit may provide the content outputting device with contents corresponding to a channel number included in the received content request signal.

When the channel map storing unit receives a content termination signal from the user terminal and terminates the provision of the contents, the channel map storing unit may store a point, at which the contents are terminated, and when the content providing unit receives the content request signal for the terminated contents from the user terminal, the content providing unit may provide the contents from the termination point of the contents.

When the one or more contents registered in the stored channel map are updated, the channel map generating unit may register the one or more updated contents, and the content providing unit may provide the user terminal or the content outputting device with content list information, in which the one or more registered contents and one or more updated contents are aligned, in such a manner that contents, which had been provided to the content outputting device, in the content list information are processed to be dark and provided.

The content providing unit may generate recommended content list information based on the one or more elements of received content information and provide the user terminal with the generated recommended content list information, and when the one or more contents registered in the stored channel map are voice contents, the content providing unit may combine a predetermined picture or video contents with the voice contents and provide the content outputting device with the combined picture or video contents and voice contents.

The content providing unit may provide the user terminal with the one or more registered contents, and when the one or more registered contents are terminated, the content providing unit may provide the one or more updated contents in succession.

The content providing unit may provide the one or more registered contents and the one or more updated contents in succession, in such a manner that the content providing unit may skip the contents which had been previously provided to the content outputting device and provide only the content which have not been provided.

The channel map storing unit may receive a selection of one of the one or more stored channel maps from the user terminal, and the content providing unit may provide the one or more contents registered in the selected channel map.

The content information may include one or more of the kind of contents, preference, a broadcasting company, and country.

Another exemplary embodiment of the present invention provides a method of providing contents, the method including: receiving one or more elements of content information from a user terminal; registering one or more contents and generating a channel map based on the one or more elements of received content information; and storing the generated channel map, in which the receiving includes providing an external server with the generated channel map or receiving a previously generated channel map from the external server, and the storing includes storing any one or more of the generated channel map and the previously generated channel map.

The method may further include providing a content outputting device with one or more contents registered in the channel map stored in the channel map storing unit, and the providing may include, when a content request signal is received from the user terminal, providing the content outputting device with contents corresponding to a channel number included in the received content request signal.

The storing may further include, when a content termination signal is received from the user terminal and the provision of the contents is terminated, storing a point, at which the contents are terminated, and the providing may further include, when the content request signal for the terminated contents is received from the user terminal, providing the contents from the termination point of the contents.

The generating may include, when the one or more contents registered in the stored channel map are updated, registering the one or more updated contents, and the providing may further include, providing the user terminal or the content outputting device with content list information, in which the one or more registered contents and one or more updated contents are aligned, in such a manner that contents, which had been provided to the content outputting device, in the content list information are processed to be dark and provided.

The providing may further include: generating recommended content list information based on the one or more elements of received content information and providing the user terminal with the generated recommended content list information; and when the one or more contents registered in the stored channel map are voice contents, combining a predetermined picture or video contents with the voice contents and providing the content outputting device with the combined picture or video contents and voice contents.

The providing may further include providing the user terminal with the one or more registered contents, in which when the one or more registered contents are terminated, providing the one or more updated contents in succession.

The providing may further include providing the one or more registered contents and the one or more updated contents in succession, in such a manner the contents which had been previously provided to the content outputting device may be skipped and only the contents which have not been provided are provided.

The storing may further include receiving a selection of one of the one or more stored channel maps from the user terminal, and the providing may include providing the one or more contents registered in the selected channel map.

The present invention may register one or more contents based on one or more elements of content information received from a user terminal and generate a channel map, and provide the user terminal with the contents registered in the generated channel map, thereby selectively providing various kinds of dispersed contents according to preference of a user.

The present invention may provide the generated channel map to an external server and receive and store a channel map that is pre-stored in the external server, so that the channel map may be shared with other people through the external server.

When the contents registered in the channel map are updated, the present invention automatically updates the contents, so that it is not necessary to re-register the corresponding contents in order to receive the updated contents.

The present invention may provide the registered contents and the updated contents, in such a manner that the contents, which had been previously provided, are processed to be dark, thereby enabling a user to discriminate whether the contents are the previously received contents.

### BRIEF DESCRIPTION OF THE DRAWINGS

FIG. 1 is a diagram schematically illustrating constituent elements of a content providing apparatus 100 according to an exemplary embodiment of the present invention.

FIG. 2 is a diagram schematically illustrating a channel map generated by a channel map generating unit 120 in the content providing apparatus 100 according to the exemplary embodiment of the present invention.

FIG. 3 is a diagram schematically illustrating a form, in which a channel map storing unit 130 provides the generated channel map to an external server 20 in the content providing apparatus 100 according to the exemplary embodiment of the present invention.

FIG. 4 is a diagram schematically illustrating a form of receiving a previously generated channel map from the external server 20 in the content providing apparatus 100 according to the exemplary embodiment of the present invention.

FIG. 5 is a diagram schematically illustrating a form, in which content list information provided by a content providing unit 140 is output from a user terminal 10 in the content providing apparatus 100 according to the exemplary embodiment of the present invention.

FIGS. 6 and 7 are flowcharts for describing a series of processes providing a user terminal with contents by using the content providing apparatus 100 according to the exemplary embodiment of the present invention.

### DETAILED DESCRIPTION

Hereinafter, exemplary embodiments will be provided for helping to understand the present invention. However, the following exemplary embodiment is simply provided only for helping the person skilled in the art to more easily understand the present invention, and the contents of the present invention is not limited by the exemplary embodiment.

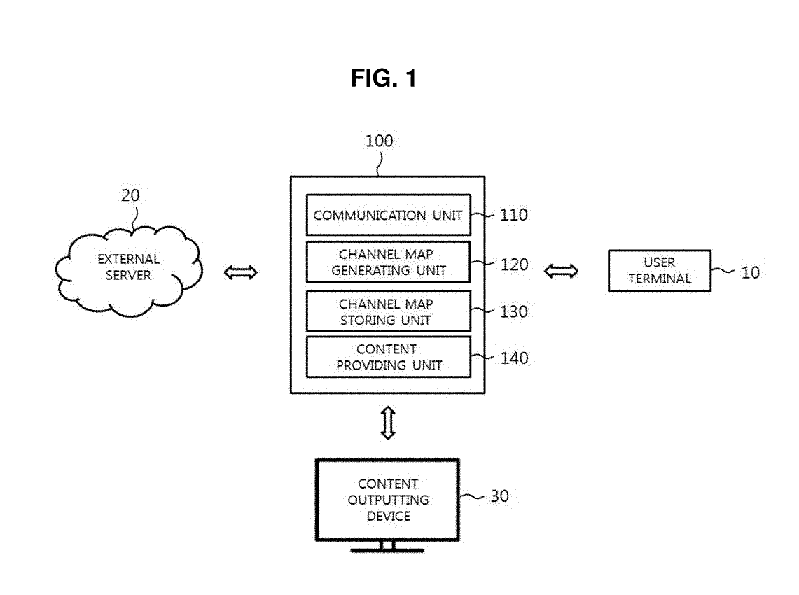

FIG. 1 is a diagram schematically illustrating constituent elements of a content providing apparatus 100 according to an exemplary embodiment of the present invention.

Referring to FIG. 1, the content providing apparatus 100 according to the exemplary embodiment of the present invention may include a communication unit 110, a channel map generating unit 120, a channel map storing unit 130, and a content providing unit 140.

First, the communication unit 110 may receive one or more elements of content information from a user terminal 10.

Herein, the contents may be data generated by producing text, a voice, an image, a picture, and the like including various information by a digital scheme in order to use the contents in a wired/wireless electric communication network. For example, the contents may include text contents, picture content, voice contents, such as music and a radio, broadcasting video contents, such as a public TV channel, a cable TV channel, a broadcasting video on demand (VOD), provided by a broadcasting company and a communication company, and personal video contents, such as YouTube and Podcast, provided by using the Internet network.

Herein, the content information may be information representing an attribute of the foregoing text, picture, voice, and video contents. For example, the content information may include one or more of the kind of contents, preference, a broadcasting company, and country.

Herein, the user terminal 10 may include any one or more of a mobile communication terminal, a personal digital assistant (PDA), a laptop computer, a smart phone, a netbook computer, a mobile Internet device (MID), an ultra-mobile personal computer (UMPC), and a table PC of a user using the content providing apparatus 100 according to the exemplary embodiment of the present invention. Further, the user terminal 10 may have a communication function, such as a remote control, and may include a control device which is capable of controlling the content outputting device 30. The present invention is described in the form, in which the content providing apparatus 100 according to the exemplary embodiment of the present invention is used through the user terminal 10, but the present invention is not limited thereto, and the content providing apparatus 100 according to the exemplary embodiment of the present invention may also be used by using only the content outputting device 30 without using the user terminal 10. For example, when the content outputting device 30 is a smart TV which is connected with the Internet network and is capable of using an application, the smart TV may simultaneously serve as the user terminal 10 and the content outputting device 30.

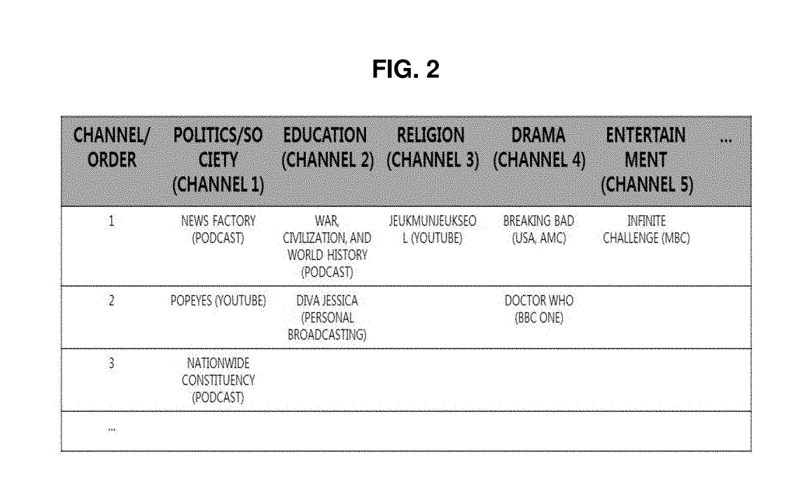

The channel map generating unit 120 may register one or more contents based on information about the one or more contents received through the communication unit 110 and generate a channel map. Hereinafter, the channel map generating unit 120 will be described in more detail with reference to FIG. 2.

FIG. 2 is a diagram schematically illustrating a channel map generated by the channel map generating unit 120 in the content providing apparatus 100 according to the exemplary embodiment of the present invention.

Referring to FIG. 2, the channel map generating unit 120 may classify one or more contents based on information about the one or more contents. For example, the channel map generating unit 120 may divide one or more contents into a politics/society channel, an education channel, a religion channel, a drama channel, and an entertainment channel, and register one or more contents to each channel to generate a channel map.

In the exemplary embodiment, the channel map generating unit 120 may match one or more contents with a channel number and register the one or more contents. Herein, the channel number may be an identification number for the contents registered in the channel map. As one example, when one or more contents are a drama video, an entertainment video, and an education video, the channel map generating unit 120 may set a channel number of the drama contents to No. 1, a channel number of the entertainment contents to No. 2, and a channel number of the education video to No. 3, and match the set channel number and the corresponding contents to register the contents. Then, when a channel number is received from the user terminal 10, the content providing unit 140, which is to be described below, may provide the contents matched to the received channel number to the content outputting device 30. For example, when the channel number input from the user terminal 10 is N. 2, the content providing unit 140 may provide the entertainment video among the contents registered in the channel map to the content outputting device 30. Herein, the content outputting device 30 may be a device which is capable of outputting contents. For example, the content outputting device 30 may include a TV, a PC, a laptop PC, a mobile phone, a tablet PC, a PDA, an MP3 player, a kiosk, an electronic album, and a table display device.

In the exemplary embodiment, the channel map generating unit 120 may set a channel number for one or more contents based on an order of an input of one or more elements of content information from the user terminal 10. For example, when the contents are input in an order of drama contents, entertainment contents, and education contents, the channel map generating unit 120 may set a channel number of the drama contents to No. 1, a channel number of the entertainment contents to No. 2, and a channel number of the education contents to No. 3.

In another exemplary embodiment, the communication unit 110 may receive the channel number together with the one or more elements of content information from the user terminal 10, and the channel map generating unit 120 may match the received channel number with the corresponding contents and register the contents. For example, when content information about the drama contents is input and a No. 10 that is a channel number is input at the same time, the channel map generating unit 120 may set the drama contents to the channel number 10.

In the exemplary embodiment, the channel map generating unit 120 may correct the generated channel map. For example, when the user desires to add specific contents to the generated channel map, and the user desires to delete one of the one or more registered contents, or desires to change a channel number of the one or more registered contents, the user may transmit a channel map correcting signal by using the user terminal 10, and when the channel map generating unit 120 receives the channel map correcting signal, the channel map generating unit 120 may output a user interface, through which the channel map may be corrected, to the user terminal 10 or the content outputting device 30.

In the exemplary embodiment, when one or more contents registered in the channel map are updated, the channel map generating unit 120 may register the one or more updated contents. For example, when the one or more contents registered in the channel map are the weekly broadcasted TV entertainment program, a Video On Demand (VOD) of a new episode is weekly updated. In this case, the channel map generating unit 120 may update the registered TV entertainment program and additionally register the VOD for the new episode. Accordingly, the user using the content providing apparatus 100 according to the exemplary embodiment of the present invention may automatically receive the updated contents without a need to input and add information on the contents whenever the contents are updated weekly.

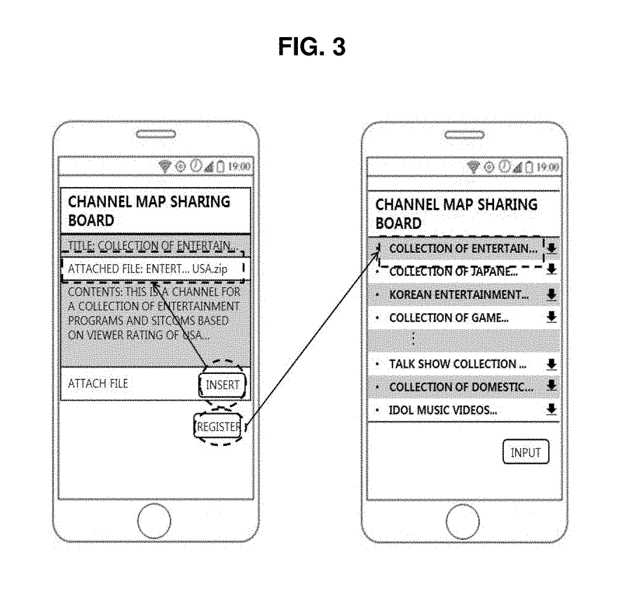

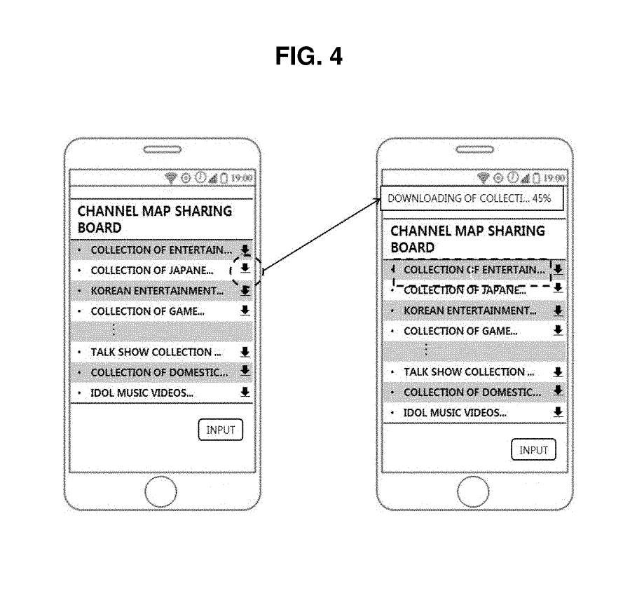

In the exemplary embodiment, the communication unit 110 may provide the channel map generated in the channel map generating unit 120 to the external server 20 or receive a previously generated channel map from the external server 20. Hereinafter, this will be described in more detail with reference to FIGS. 3 and 4.

FIG. 3 is a diagram schematically illustrating a form, in which the channel map storing unit 130 provides the generated channel map to the external server 20 in the content providing apparatus 100 according to the exemplary embodiment of the present invention, and FIG. 4 is a diagram schematically illustrating a form of receiving a previously generated channel map from the external server 20 in the content providing apparatus 100 according to the exemplary embodiment of the present invention.

Referring to FIGS. 3 and 4, the communication unit 110 may be connected with the external server 20, and the user may be connected with the external server 20 through the user terminal 10 and share the generated channel map with another user terminal 10. Herein, the external server 20 may be connected with the content providing apparatus 100 according to the exemplary embodiment of the present invention through a communication network, and may be a sub system which receives and stores the generated channel map from the one or more user terminals 10. For example, the external server 20 may be a web server using the Internet network. For example, when the external server 20 is a web server, the external server 20 may be installed in the user terminal 10 in a form of an application usable in a smart phone and a smart TV, and the user may access the application through the user terminal 10 to be connected with the external server 20. The user registers the channel map generated based on user's preference within the application through the user terminal 10, thereby providing the generated channel map to the external server 20. To this end, the channel map may be generated in a form of one data file.

The user may receive a previously generated channel map from the external server 20. Herein, the previously generated channel map may be the channel map which other users generate according to users' preference and provide to the external server 20. For example, the user may receive the previously generated channel map by touching a download button of a channel map desired to be downloaded among the previously generated channel maps registered in the external server 20.

In another exemplary embodiment, the channel map generating unit 120 may analyze a pattern of one or more input contents based on one or more elements of input contents information, extract a recommended channel map from the external server 20 based on the analyzed pattern, categorize the extracted recommended channel map, and provide the categorized recommended channel map to the user terminal 10 or the content outputting device 30.

In still another exemplary embodiment, the communication unit 110 directly receives the channel map generated by the content providing apparatus 100 of another adjacent user, thereby receiving the channel map of another user.

In still yet another exemplary embodiment, the content providing apparatus 100 according to the exemplary embodiment of the present invention may include an interface terminal (not illustrated) connected with an external device. The interface terminal may be connected with a storage device, such as a mobile USB memory, and fetch and store a file stored in the storage device, such as the mobile USB memory. For example, when one or more channel map files are stored in the mobile USB memory, the interface terminal may fetch the one or more stored channel map files and store the one or more channel map files in the channel map storing unit 130.

Referring back to FIG. 1, the channel map storing unit 130 may store any one or more of the channel map generated in the channel map generating unit 120 and the channel map received from the external server 20. For example, the channel map storing unit 130 may include one or more databases. The database is a storing place, in which data may be combined and managed, and may store one or more channel maps generated in a form of a data file.

In the exemplary embodiment, the channel map storing unit 130 may receive a selection of one among the one or more stored channel maps from the user terminal 10, and provide the selected channel map to the content providing unit 140 which is to be described below, thereby enabling the content providing unit 140 to provide one or more contents registered in the selected channel map.

The content providing unit 140 may provide the content outputting device 30 with the one or more contents registered in the channel map that is stored in the channel map storing unit 130.

In the exemplary embodiment, when the content providing unit 140 receives a content request signal from the user terminal 10, the content providing unit 140 may provide the content outputting device 30 with contents corresponding to a channel number included in the received content request signal. Herein, the content request signal may be a signal input through the user terminal 10 so as for the user to receive the contents. For example, the user may input a channel number of the content outputting device 30 through a remote controller in order to receive the contents. In this case, the input channel number may be the content request signal.

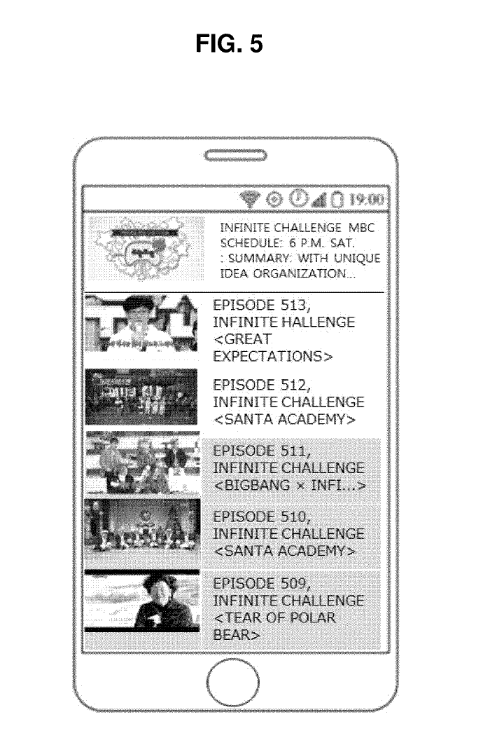

In the exemplary embodiment, the channel map generating unit 120 may align the one or more registered contents and the one or more updated contents, and generate content list information, and the content providing unit 140 may provide the user terminal 10 or the content outputting device 30 with the generated content list information. Hereinafter, this will be described in more detail with reference to FIG. 5.

FIG. 5 is a diagram schematically illustrating a form, in which the content list information provided by the content providing unit 140 is output from the user terminal 10 in the content providing apparatus 100 according to the exemplary embodiment of the present invention.

Referring to FIG. 5, the content providing unit 140 may provide the user terminal 10 or the content outputting device 30 with the content list information in which the one or more registered contents and the one or more updated contents are aligned. Herein, the content list information may be information, in which the one or more contents are sequentially listed. The user may receive the content list information by using the user terminal 10 or the content outputting device 30, thereby recognizing information about the registered contents and the updated contents at a glance.

In the exemplary embodiment, the content providing unit 140 provides the user terminal 10 or the content outputting device 30 with the content list information, in such a manner that the contents which had been provided to the content outputting device 30 may be processed to be dark in the content list information and be provided to the user terminal 10 or the content outputting device 30. For example, when the contents of episodes 509 to 511 among episodes 509 to 513 had been previously provided as described in FIG. 5, the contents of episodes 509 to 511 are processed to be darker than those of episodes 512 and 513, thereby enabling the user to recognize that the contents of episodes 509 to 511 had been previously provided.

In another exemplary embodiment, the content providing unit 140 may delete the contents, which had been provided to the content outputting device 30, from the content list information, and provide only the contents which are not provided to the content outputting device 30.

Referring back to FIG. 1, the content providing unit 140 provides the user terminal 10 with the one or more registered contents, in such a manner that when the one or more registered contents are terminated, the content providing unit 140 may provide one or more updated contents in succession. For example, when the user receives and views a TV entertainment program of episode 511 and the TV entertainment program of episode 511 is terminated, a TV entertainment program of episode 512 is automatically executed, so that there is an advantage in that the user does not need to perform an additional operation for playing a next episode.

In another exemplary embodiment, the content providing unit 140 provides the one or more updated contents in succession, and transmits an alarm message notifying that the contents are provided to the user terminal 10 or the content outputting device 30 in succession, and when the content providing unit 140 receives a play request signal from the user terminal 10 or the content outputting device 30, the content providing unit 140 may play the one or more updated contents in succession.

In the exemplary embodiment, the content providing unit 140 provides the one or more registered contents and the one or more updated contents in succession, in such a manner that the content providing unit 140 may skip the contents which had been previously provided to the content outputting device 30 and provide only the content which have not been provided. For example, in continuously playing an entertainment program of episodes 1 to 10, when the user previously viewed the entertainment program of episodes 2, 3 and 5, the content providing unit 140 may play the contents in succession in an order of episodes 1, 4, and 6 to 10.

In another exemplary embodiment, the content providing unit 140 provides the one or more updated contents in succession, and when the contents to be provided after the contents, of which the play is terminated, in succession are the previously provided contents, the content providing unit 140 transmits an alarm message based on which the user may recognize that the contents to be provided in succession are the previously provided contents, and when the content providing unit 140 receives a skip signal from the user terminal 10 or the content outputting device 30, the content providing unit 140 may skip the previously viewed contents and provide only non-viewed contents.

In the exemplary embodiment, the content providing unit 140 may provide the contents from a point at which the contents are terminated. For example, when the content providing unit 140 receives a content termination signal from the user terminal 10, the content providing unit 140 may terminate the provision of the currently provided contents, and the channel map storing unit 130 may store the point, at which the terminated contents are terminated. Then, when the content providing unit 140 receives a content request signal for the terminated contents from the user terminal 10, the content providing unit 140 may fetch the corresponding contents and information on the point at which the corresponding contents are terminated from the channel map storing unit 130 and provide the user terminal 10 with the corresponding contents and the information on the point, so that the user may view the corresponding contents from the previous termination point again.

In the exemplary embodiment, the content providing unit 140 may generate recommended content list information based on the one or more elements of the content information input through the communication unit 110, and provide the user terminal 10 with the generated recommended content list information. Herein, the recommended content list information may be a list including one or more recommended contents desired to be recommended to the user. For example, when the user inputs a plurality of elements of content information including a Korean entertainment program and a reality program as a result of the analysis of the one or more elements of the content information input through the communication unit 110, the content providing unit 140 may extract one or more entertainment programs having lots of popularity and number of recommendations among the Korean reality entertainment programs which are not input from the user terminal 10, list the extracted entertainment program, and provide the user terminal 10 or the content outputting device 30 with the listed entertainment program.

In the exemplary embodiment, when the one or more contents registered in the channel map stored in the channel map storing unit 130 are voice contents and the user desires to receive the corresponding voice contents through the user terminal 10, the content providing unit 140 may combine predetermined pictures or image contents with the voice contents and provide the user terminal 10 or the content outputting device 30 with the combined contents. For example, when the registered voice contents are a song of a specific singer, the content providing unit 140 combines the song with an album cover image of the specific singer and provide the user terminal 10 or the content outputting device 30 with the combined song and image, so that the contents may be provided in a form in which the album cover of the specific singer is displayed on a screen of the content outputting device 30, and the song of the specific singer is output through a speaker.

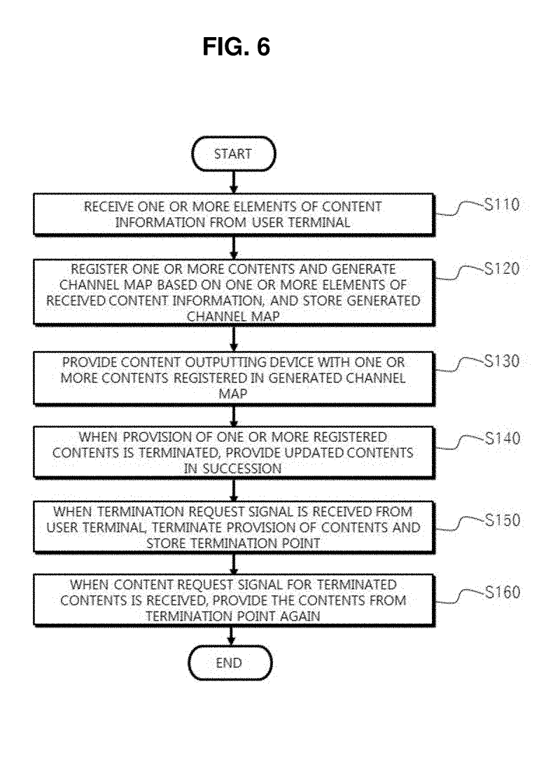

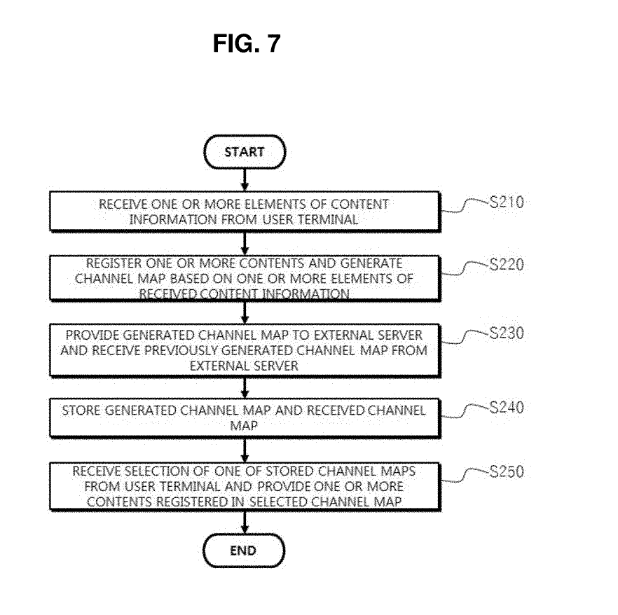

Hereinafter, a method of providing contents by using the content providing apparatus 100 according to the exemplary embodiment of the present invention will be described with reference to FIGS. 6 and 7.

FIGS. 6 and 7 are flowcharts for describing a series of processes providing a user terminal with contents by using the content providing apparatus 100 according to the exemplary embodiment of the present invention.

Referring to FIG. 6, first, one or more elements of content information are received from a user terminal (S110). The one or more contents are registered based on the one or more contents received in operation S110 to generate a channel map, and the generated channel map is stored (S120). Then, when a content request signal is received from the user terminal, contents corresponding to a channel number included in the content request signal among the one or more contents registered in the generated channel map are provided to the content outputting device (S130). When the contents received from operation S130 are terminated, updated contents are provided in succession (S140).

In this case, when a termination request signal is received from the user terminal, the provision of the contents, which have been provided in operations S130 and S140, is terminated, and a termination point is stored (S150). Then, when a content request signal for the terminated contents is received from the user terminal, the corresponding contents are provided from the termination point again (S160).

Referring to FIG. 7, when one or more elements of content information are received from a user terminal (S120), and the one or more contents are registered based on the one or more elements of received content information to generate a channel map (S220). Operations S210 and S220 are the same as operations S110 and S120 of FIG. 6. The channel map generated in operation S220 is provided to an external server, or a previously generated channel map is received from the external server (S230), and the generated channel map and the received channel map are stored (S250).

Then, one is selected in the stored channel map from the user terminal, and one or more contents registered in the selected channel map are provided (S250).

The aforementioned content providing method has been described with reference to the flowchart illustrated in the drawing. For the simple description, the method is illustrated in a series of blocks and described, but the present invention is not limited to the sequence of the blocks, and some blocks may be performed in a different order or at the same time as that of other blocks illustrated and described in the present specification, and various branches, flow paths, and block sequences achieving the same or similar result may be carried out. Further, all of the blocks illustrated for carrying out the method described in the present specification may not be required.

The present invention has been described with reference to the exemplary embodiments, but those skilled in the art may understand that the present invention may be variously modified and changed without departing from the spirit and the area of the present invention described in the accompanying claims.

What is claimed is:

1. An apparatus for providing contents, the apparatus comprising:
a communication unit which receives one or more elements of content information from a user terminal;
a channel map generating unit which registers one or more contents and generating a channel map based on the one or more elements of received content information; and
a channel map storing unit which stores the generated channel map,
wherein the communication unit provides an external server with the generated channel map or receives a previously generated channel map from the external server, and
the channel map storing unit stores any one or more of the generated channel map and the previously generated channel map.

2. The apparatus of claim 1, further comprising:
a content providing unit which provides a content outputting device with one or more contents registered in the channel map stored in the channel map storing unit,
wherein when the content providing unit receives a content request signal from the user terminal, the content providing unit provides the content outputting device with contents corresponding to a channel number included in the received content request signal.

3. The apparatus of claim 2, wherein when the channel map storing unit receives a content termination signal from the user terminal and terminates the provision of the contents, the channel map storing unit stores a point, at which the contents are terminated, and
when the content providing unit receives the content request signal for the terminated contents from the user terminal, the content providing unit provides the contents from the termination point of the contents.

4. The apparatus of claim 2, wherein when the one or more contents registered in the stored channel map are updated, the channel map generating unit registers the one or more updated contents, and
the content providing unit provides the user terminal or the content outputting device with content list information, in which the one or more registered contents and one or more updated contents are aligned, in such a manner that contents, which had been provided to the content outputting device, in the content list information are processed to be dark and provided.

5. The apparatus of claim 2, wherein the content providing unit generates recommended content list information based on the one or more elements of received content information and provides the user terminal with the generated recommended content list information, and
when the one or more contents registered in the stored channel map are voice contents, the content providing unit combines a predetermined picture or video contents with the voice contents and provides the content outputting device with the combined picture or video contents and voice contents.

6. A method of providing contents, the method comprising:
receiving one or more elements of content information from a user terminal;
registering one or more contents and generates a channel map based on the one or more elements of received content information; and
storing the generated channel map,
wherein the receiving includes providing an external server with the generated channel map or receiving a previously generated channel map from the external server, and
the storing includes storing any one or more of the generated channel map and the previously generated channel map.

7. The method of claim 6, further comprising:
providing a content outputting device with one or more contents registered in the channel map stored in the channel map storing unit,
wherein the providing includes, when a content request signal is received from the user terminal, providing the content outputting device with contents corresponding to a channel number included in the received content request signal.

8. The method of claim 7, wherein the storing further includes, when a content termination signal is received from the user terminal and the provision of the contents is terminated, storing a point, at which the contents are terminated, and
the providing further includes, when the content request signal for the terminated contents is received from the user terminal, providing the contents from the termination point of the contents.

9. The method of claim 7, wherein the generating includes, when the one or more contents registered in the stored channel map are updated, registering the one or more updated contents, and
the providing further includes, providing the user terminal or the content outputting device with content list information, in which the one or more registered contents and one or more updated contents are aligned, in such a manner that contents, which had been provided to the content outputting device, in the content list information are processed to be dark and provided.

10. The method of claim 7, wherein the providing further includes:
generating recommended content list information based on the one or more elements of received content information and providing the user terminal with the generated recommended content list information; and
when the one or more contents registered in the stored channel map are voice contents, combining a predetermined picture or video contents with the voice contents and providing the content outputting device with the combined picture or video contents and voice contents.
